(19) United States
(12) Patent Application Publication
(10) Pub. No.: US 2022/0146476 A1
(43) Pub. Date: May 12, 2022

(54) ION SUPPRESSOR

(71) Applicant: SHIMADZU CORPORATION, Kyoto (JP)

(72) Inventors: Masanori FUJIWARA, Kyoto (JP); Katsumasa SAKAMOTO, Kyoto (JP)

(21) Appl. No.: 17/441,665

(22) PCT Filed: Mar. 27, 2019
(86) PCT No.: PCT/JP2019/013387

§ 371 Date: Sep. 21, 2021

(51) Int. Cl. G01N 30/96; G01N 30/02

(52) U.S. Cl. CPC G01N 30/96; G01N 2030/965; G01N 30/02

(57) ABSTRACT

First and second electrode liquid seal members are arranged between a first electrode and a second electrode. First and second ion exchange membranes are arranged between a first electrode liquid seal member and a second electrode liquid seal member. An eluent seal member is arranged between a first ion exchange membrane and a second ion exchange membrane. Ion exchange is performed between an eluent that passes through an eluent flow path of the eluent seal member from a separation column and an electrode liquid that passes through each of electrode liquid flow paths of the first and second electrode liquid seal members. In a first surface of the eluent seal member that comes into contact with the first ion exchange membrane, a first projection that surrounds the entire circumference of the eluent flow path to extend along the edge of the eluent flow path and projects toward the first ion exchange membrane is formed.

### TECHNICAL FIELD

The present invention relates to an ion suppressor.

### BACKGROUND ART

In an ion chromatograph, a sample to be analyzed is introduced into a separation column together with an eluent. A sample is separated into ion species components by passing through the separation column and introduced into a flow cell of a detector together with the eluent. A chromatogram is generated by sequential detection of electrical conductances of sample components that have been introduced into the flow cell. An ion suppressor may be arranged between the separation column and the detector.

In the suppressor described in Patent Document 1, a sample stream gasket is arranged between a pair of gaskets. A chromatography effluent that has passed through the separation column is introduced into a sample stream screen of the sample stream gasket. A detector effluent that has flowed out from the detector branches with the use of a three-way valve and is introduced into ion exchange screens of the pair of gaskets. Ion exchange is performed by electrodialysis between the detector effluent and the chromatography effluent, so that the electrical conductance of the chromatography effluent is suppressed.
[Patent Document 1] JP 4750279 B2

### SUMMARY OF INVENTION

### Technical Problem

In a case where dialysis efficiency of the ion suppressor is low, an electrical conductance of an eluent is not so low. Therefore, the background of a chromatogram is increased, so that accuracy of sample analysis is degraded. Thus, it is desired that dialysis efficiency of the ion suppressor is improved.

An object of the present invention is to provide an ion suppressor with improved dialysis efficiency.

### Solution to Problem

An aspect according to the present invention relates to an ion suppressor that performs ion exchange between an eluent and an electrode liquid from a separation column of an ion chromatograph, and includes first and second electrodes, first and second electrode liquid seal members arranged between the first electrode and the second electrode, and respectively have electrode liquid flow paths through which an electrode liquid passes, first and second ion exchange membranes arranged between the first electrode liquid seal member and the second electrode liquid seal member, and an eluent seal member arranged between the first ion exchange membrane and the second ion exchange membrane and has an eluent flow path through which an eluent passes, wherein the eluent seal member has a first surface that comes into contact with the first ion exchange membrane, and a first projection that surrounds an entire circumference of the eluent flow path to extend along an edge of the eluent flow path and projects toward the first ion exchange membrane is formed.

### Advantageous Effects of Invention

With the present invention, dialysis efficiency of an ion suppressor can be improved.

### BRIEF DESCRIPTION OF THE DRAWINGS

FIG. 1 is a diagram showing the configuration of an ion chromatograph including an ion suppressor according to one embodiment of the present invention.

FIG. 2 is an exploded perspective view showing the configuration of the ion suppressor of FIG. 1.

FIG. 3 is a plan view of an eluent seal member of FIG. 2.

FIG. 4 is a cross sectional view taken along the line A-A of the eluent seal member of FIG. 3.

FIG. 5 is a cross sectional view taken along the line B-B of the eluent seal member of FIG. 3.

FIG. 6 is a diagram for explaining the operation of the ion suppressor of FIG. 2.

FIG. 7 is a picture showing a result of evaluation of an eluent seal member according to an inventive example.

FIG. 8 is a picture showing a result of evaluation of an eluent seal member according to a comparative example.

### DESCRIPTION OF EMBODIMENTS

### (1) Configuration of Ion Chromatograph

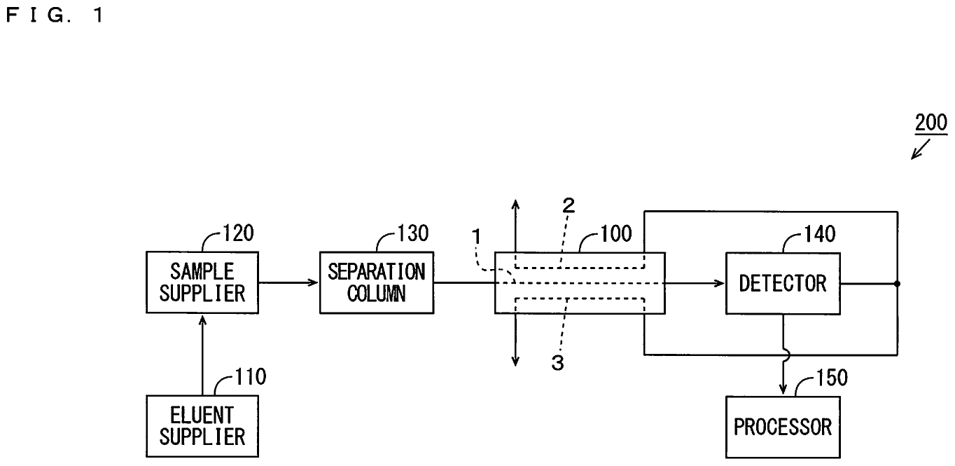

An ion suppressor according to embodiments of the present invention will be described below in detail with reference to the drawings. FIG. 1 is a diagram showing the configuration of an ion chromatograph including the ion suppressor according to one embodiment of the present invention. As shown in FIG. 1, the ion chromatograph 200 includes the ion suppressor 100, an eluent supplier 110, a sample supplier 120, a separation column 130, a detector 140 and a processor 150.

The eluent supplier 110 includes a chemical liquid bottle, a liquid sending pump and a degassing device, for example, and supplies an eluent such as an aqueous solution as a mobile phase. The sample supplier 120 is an injector, for example, and introduces a sample to be analyzed to the separation column 130 together with an eluent supplied by the eluent supplier 110. The separation column 130 is stored in a column oven (not shown) and adjusted to a predetermined constant temperature. The separation column 130 separates an introduced sample into ion species components.

The detector 140 is an electrical conductance detector and sequentially detects the electrical conductances of a sample and an eluent that have passed through the ion suppressor 100 from the separation column 130. The processor 150 generates a chromatogram representing the relationship between a retention time of each ion species component and an electrical conductance by processing a result of detection by the detector 140.

The ion suppressor 100 has an eluent flow path 1 and electrode liquid flow paths 2, 3 and is arranged between the separation column 130 and the detector 140. A sample and an eluent that have passed through the separation column 130 are guided to the detector 140 through the eluent flow path 1. Further, an eluent that has passed through the detector 140 passes through the electrode liquid flow paths 2, 3 as an electrode liquid and is then discarded. In the ion suppressor 100, ion exchange is performed by electrodialysis, so that an electrical conductance of an eluent that has passed through the eluent flow path 1 is lowered. Details of the ion suppressor 100 will be described below.

### (2) Configuration of Ion Suppressor

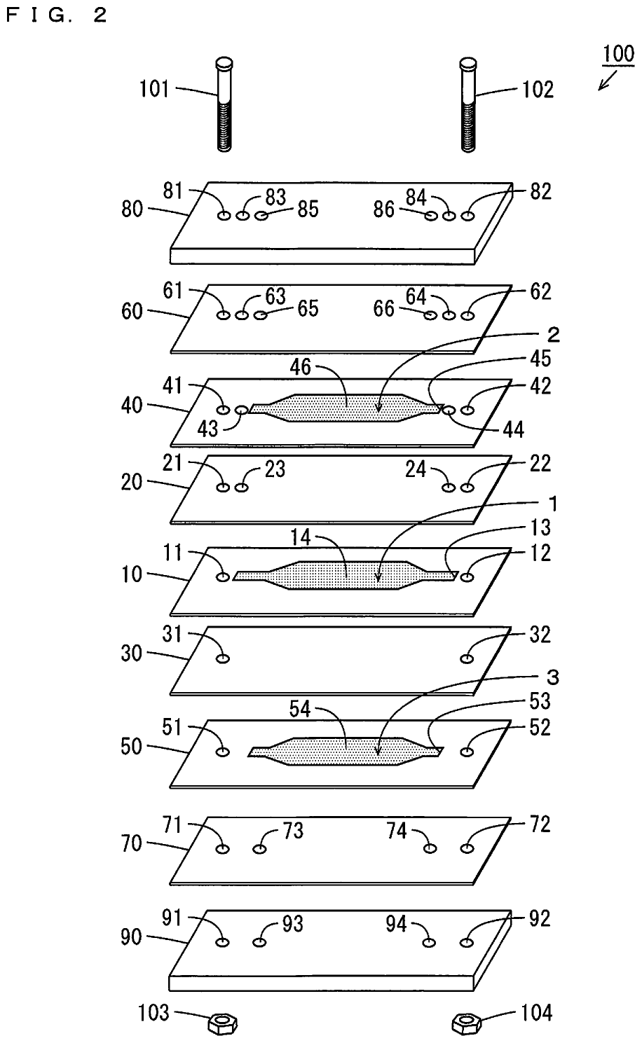

FIG. 2 is an exploded perspective view showing the configuration of the ion suppressor 100 of FIG. 1. As shown in FIG. 2, the ion suppressor 100 includes an eluent seal member 10, a pair of ion exchange membranes 20, 30, a pair of electrode liquid seal members 40, 50, a pair of electrodes 60, 70 and a pair of support members 80, 90. Each of the eluent seal member 10, the ion exchange membranes 20, 30, the electrode liquid seal members 40, 50, the electrodes 60, 70 and the support members 80, 90 has an elongated shape extending in one direction (hereinafter referred to as a flow-path direction).

The eluent seal member 10 has through holes 11, 12 and an opening 13. The through holes 11, 12, are respectively arranged in one end portion and the other end portion in the flow-path direction. The opening 13 is arranged between the through hole 11 and the through hole 12 to extend in the flow-path direction. The space in the opening 13 constitutes the eluent flow path 1. In the present embodiment, a mesh member 14 is provided in the eluent flow path 1. Details of the eluent seal member 10 will be described below.

The ion exchange membranes 20, 30 are cation exchange membranes in a case where ions to be measured are anions, and are anion exchange membranes in a case where ions to be measured are cations. The ion exchange membrane 20 has through holes 21 to 24. The through holes 21, 23 are arranged in one end portion in the flow-path direction in this order from the one end portion to the other end portion. The through holes 22, 24 are arranged in the other end portion in the flow-path direction in this order from the other end portion to the one end portion. The ion exchange membrane 30 has through holes 31, 32. The through holes 31, 32 are respectively arranged in one end portion and the other end portion in the flow-path direction.

The electrode liquid seal member 40 has through holes 41 to 44 and an opening 45. The through holes 41, 43 are arranged in one end portion in the flow-path direction in this order from the one end portion to the other end portion. The through holes 42, 44 are arranged in the other end portion in the flow-path direction in this order from the other end portion to the one end portion. The opening 45 is arranged between the through hole 43 and the through hole 44 to extend in the flow-path direction. The space in the opening 45 constitutes the electrode liquid flow path 2. In the present embodiment, a mesh member 46 is provided in the electrode liquid flow path 2.

The electrode liquid seal member 50 has through holes 51, 52 and an opening 53. The through holes 51, 52 are respectively arranged in one end portion and the other end portion in the flow-path direction. The opening 53 is arranged between the through hole 51 and the through hole 52 to extend in the flow-path direction. The space in the opening 53 constitutes the electrode liquid flow path 3. In the present embodiment, a mesh member 54 is provided in the electrode liquid flow path 3.

The electrode 60 is an anode, for example, and has through holes 61 to 66. The through holes 61, 63, 65 are arranged in one end portion in the flow-path direction in this order from the one end portion to the other end portion. The through holes 62, 64, 66 are arranged in the other end portion in the flow-path direction in this order from the other end portion toward the one end portion.

The electrode 70 is a cathode, for example, and has through holes 71 to 74. The through holes 71, 73 are arranged in one end portion in the flow-path direction in this order from the one end portion toward the other end portion. The through holes 72, 74 are arranged in the other end portion in the flow-path direction in this order from the other end portion toward the one end portion.

The support member 80 is formed of a resin material, for example, and has through holes 81 to 86. The through holes 81, 83, 85 are arranged in one end portion in the flow-path direction in this order from the one end portion toward the other end portion. The through holes 82, 84, 86 are arranged in the other end portion in the flow-path direction in this order from the other end portion toward the one end portion. The support member 90 is formed of a material similar to that of the support member 80 and has through holes 91 to 94. The through holes 91, 93 are arranged in one end portion in the flow-path direction in this order from the one end portion toward the other end portion. The through holes 92, 94 are arranged in the other end portion in the flow-path direction in this order from the other end portion toward the one end portion.

The support member 80, the electrode 60, the electrode liquid seal member 40, the ion exchange membrane 20, the eluent seal member 10, the ion exchange membrane 30, the electrode liquid seal member 50, the electrode 70 and the support member 90 are stacked in this order from above toward below in an up-and-down direction. In this case, in one end portion of the ion suppressor 100, the through holes 81, 61, 41, 21, 11, 31, 51, 71, 91 overlap with one another. In the other end portion of the ion suppressor 100, the through holes 82, 62, 42, 22, 12, 32, 52, 72, 92 overlap with one another.

Further, the eluent flow path 1 and the electrode liquid flow path 2 are opposite to each other with the ion exchange membrane 20 sandwiched therebetween, and the eluent flow path 1 and the electrode liquid flow path 3 are opposite to each other with the ion exchange membrane 30 sandwiched therebetween. The through holes 83, 63, 43, 23 overlap with the one end portion of the eluent flow path 1, and the through holes 84, 64, 44, 24 overlap with the other end portion of the eluent flow path 1. The through holes 85, 65 overlap with the one end portion of the electrode liquid flow path 2, and the through holes 86, 66 overlap with the other end portion of the electrode liquid flow path 2. The through holes 93, 73 overlap with the one end portion of the electrode liquid flow path 3, and the through holes 94, 74 overlap with the other end portion of the electrode liquid flow path 3.

Here, a screw member 101 is inserted into the through holes 81, 61, 41, 21, 11, 31, 51, 71, 91 from above toward below, and a screw member 102 is inserted into the through holes 82, 62, 42, 22, 12, 32, 52, 72, 92 from above toward below. Nuts 103, 104 are respectively attached to the lower end portions of the screw members 101, 102. Thus, with the eluent seal member 10, the ion exchange membranes 20, 30, the electrode liquid seal members 40, 50 and the electrodes 60, 70 integrally supported by the support members 80, 90, the ion suppressor 100 is assembled.

### (3) Eluent Seal Member

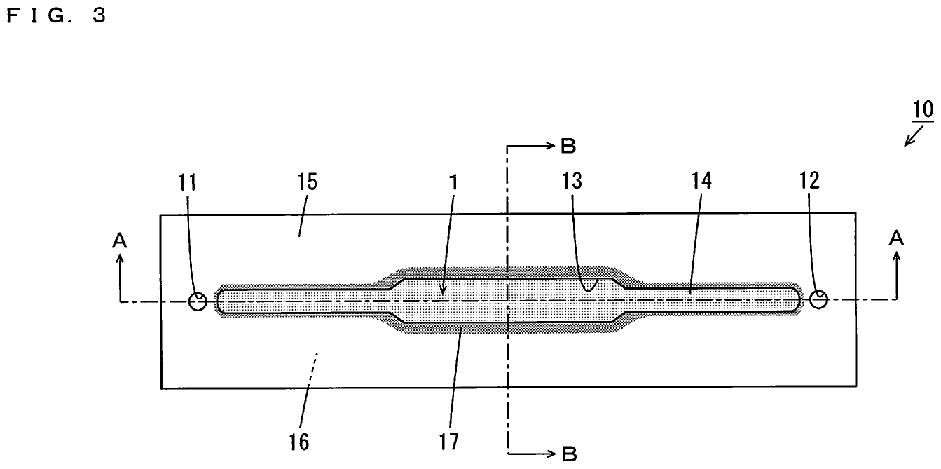

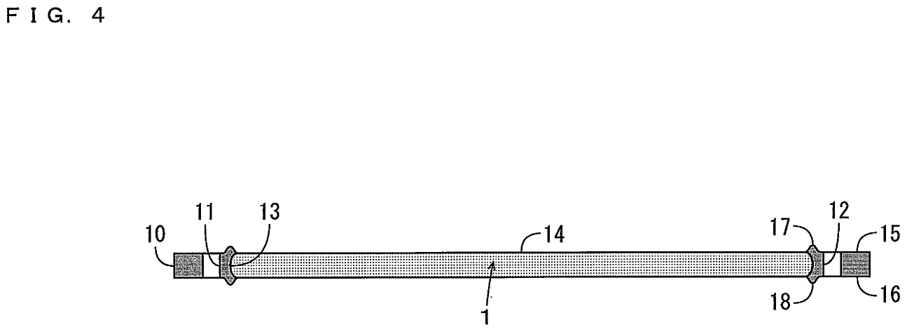

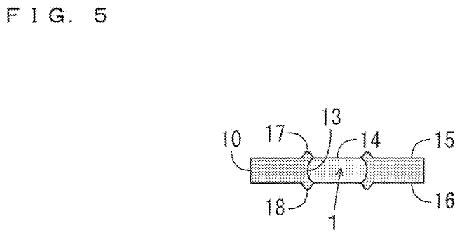

FIG. 3 is a plan view of the eluent seal member 10 of FIG. 2. FIG. 4 is a cross sectional view taken along the line A-A of the eluent seal member 10 of FIG. 3. FIG. 5 is a cross sectional view taken along the line B-B of the eluent seal member 10 of FIG. 3. As shown in FIG. 3, the eluent seal member 10 has a rectangular shape extending in the flow-path direction. The thickness of the eluent seal member 10, that is, the distance between a flat portion of an upper surface 15 and a flat portion of a lower surface 16 of the eluent seal member 10 in the up-and-down direction is not less than 1 μm and not more than 1 mm, for example, and is 200 μm in the present embodiment.

Although preferably being formed of low-density polyethylene, for example, the eluent seal member 10 may be formed of another resin material such as ultra low-density polyethylene. Low-density polyethylene means polyethylene the density of which is not less than 0.90 g/cm² and not more than 0.93 g/cm². Ultra low-density polyethylene means polyethylene the density of which is less than 0.90 g/cm².

As described above, the through holes 11, 12, are respectively formed in the one end portion and the other end portion in the flow-path direction of the eluent seal member 10. Further, the opening 13 is formed between the through hole 11 and the through hole 12 to extend in the flow-path direction. In the present embodiment, the width of the opening 13 in the vicinity of the center portion in the flow-path direction is larger than the width of the opening 13 in the vicinity of the one end portion and the other end portion. The space in the opening 13 constitutes the eluent flow path 1, and the mesh member 14 is provided in the space in the opening 13.

As shown in FIGS. 4 and 5, a projection 17 is formed on the upper surface 15 of the eluent seal member 10 to surround the entire circumferences of the opening 13. Further, a projection 18 is formed on the lower surface 16 of the eluent seal member 10 to surround the entire circumference of the opening 13. In FIG. 3, the projection 17 on the upper surface 15 of the eluent seal member 10 is indicated by the dotted pattern.

The projection amount of the projection 17, that is, the distance in the up-and-down direction from the upper surface 15 of the eluent seal member 10 to the apex of the projection 17 is not less than 3% and not more than 50% of the thickness of the eluent seal member 10, for example, and is 35 μm in the present embodiment. Similarly, the projection amount of the projection 18, that is, the distance in the up-and-down direction from the lower surface 16 of the eluent seal member 10 to the apex of the projection 18 is not less than 3% and not more than 50% of the thickness of the eluent seal member 10, for example, and is 35 μm in the present embodiment.

In a case where the ion suppressor 100 is assembled using the above-mentioned eluent seal member 10, the upper surface 15 and the lower surface 16 of the eluent seal member 10 respectively come into contact with the ion exchange membranes 20, 30 of FIG. 2. In this state, the projections 17, 18 are firmly pressed against the ion exchange membranes 20, 30. Therefore, sealability of the portion surrounding the opening 13 (the eluent flow path 1) is improved. Therefore, an eluent is confined in the eluent flow path 1 without leaking. Thus, pressure resistance of the eluent flow path 1 is improved, and dialysis efficiency is improved.

Further, in a case where the eluent seal member 10 is formed of low-density polyethylene, compressive strength is improved as compared to a case where the eluent seal member 10 is formed of ultra low-density polyethylene. In this case, the projections 17, 18 can be respectively and more firmly pressed against the ion exchange membranes 20, 30. Thus, an eluent can be more reliably confined in the eluent flow path 1.

### (4) Operation of Ion Suppressor

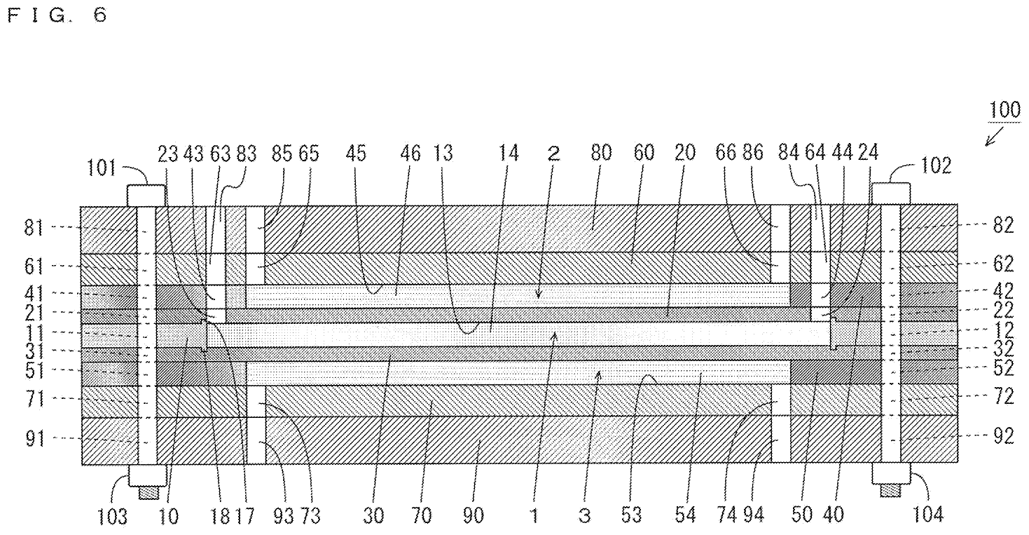

FIG. 6 is a diagram for explaining the operation of the ion suppressor 100 of FIG. 2. An eluent that includes a sample and has passed through the separation column 130 of FIG. 1 is guided to the eluent flow path 1 through the through holes 83, 63, 43, 23 from the one end portion of the ion suppressor 100 of FIG. 6 and then flows through the eluent flow path 1 toward the other end portion. At this time, because being confined by the projections 17, 18, the eluent is prevented from leaking from the eluent flow path 1. Thereafter, the eluent is guided to the detector 140 of FIG. 1 through the through holes 24, 44, 64, 84 from the other end portion of the ion suppressor 100. As described above, in the detector 140, electrical conductances of the sample and the eluent are sequentially detected.

The eluent that has passed through the detector 140 branches into two streams as an electrode liquid. One stream of electrode liquid is guided to the electrode liquid flow path 2 through the through holes 86, 66 from the other end portion of the ion suppressor 100 and then flows through the electrode liquid flow path 2 toward the one end portion. Thereafter, the one stream of electrode liquid is discharged to outside through the through holes 65, 85 from the one end portion of the ion suppressor 100. The other stream of electrode liquid is guided to the electrode liquid flow path 3 through the through holes 94, 74 from the other end portion of the ion suppressor 100 and then flows through the electrode liquid flow path 3 toward the one end portion. Thereafter, the other stream of electrode liquid is discharged to outside through the through holes 73, 93 from the other end portion of the ion suppressor 100.

A positive voltage is applied to the electrode 60, and a negative voltage is applied to the electrode 70. In this case, hydrogen ions and oxygen molecules are generated in the electrode liquid flow path 2 by electrolysis of water, and hydroxide ions and hydrogen molecules are generated in the electrode liquid flow path 3. Hydrogen ions generated in the electrode liquid flow path 2 are transmitted through the ion exchange membrane 20 to move to the eluent flow path 1, and are replaced with cations such as sodium ions or potassium ions in an eluent in the eluent flow path 1. The cations with which the hydrogen ions have been replaced are transmitted through the ion exchange membrane 30 to move to the electrode liquid flow path 3, are combined with hydroxide ions in the electrode liquid flow path 3 and then are discharged together with an electrode liquid.

With the above-mentioned operation, ion exchange is performed between the eluent that moves in the eluent flow path 1 and the electrode liquid that moves in the electrode liquid flow paths 2, 3, whereby an electrical conductance of the eluent that has passed through the eluent flow path 1 is reduced. Thus, the background of a chromatogram generated by the processor 150 of FIG. 1 is reduced. As a result, accuracy of sample analysis can be improved.

### (5) Effects

In the ion suppressor 100 according to the present embodiment, the electrode liquid seal members 40, 50 are arranged between the electrode 60 and the electrode 70. The ion exchange membranes 20, 30 are arranged between the electrode liquid seal member 40 and the electrode liquid seal member 50. The eluent seal member 10 is arranged between the ion exchange membrane 20 and the ion exchange membrane 30. Ion exchange is performed among an eluent that passes through the eluent flow path 1 of the eluent seal member 10 from the separation column 130, an electrode liquid that passes through the electrode liquid flow path 2 of the electrode liquid seal member 40 and an electrode liquid that passes through the electrode liquid flow path 3 of the electrode liquid seal member 50.

On the upper surface 15 of the eluent seal member 10 that comes into contact with the ion exchange membrane 20, the projection 17 that surrounds the entire circumference of the eluent flow path 1 to extend along the edge of the eluent flow path 1 and projects toward the ion exchange membrane 20 is formed. On the lower surface 16 of the eluent seal member 10 that comes into contact with the ion exchange membrane 30, the projection 18 is formed to surround the entire circumference of the eluent flow path 1 to extend along the edge of the eluent flow path 1 and projects toward the ion exchange membrane 30 is formed.

In this case, because an eluent is confined in the eluent flow path 1 by the projections 17, 18 surrounding the entire circumference of the eluent flow path 1, leakage of the eluent from the eluent flow path 1 is suppressed. Thus, a loss in ion exchange between an eluent and an electrode liquid is reduced. As a result, dialysis efficiency of the ion suppressor 100 can be improved.

### (6) Other Embodiments

(a) While the projections 17, 18 are respectively formed on the upper surface 15 and the lower surface 16 of the eluent seal member 10 in the above-mentioned embodiment, the embodiment is not limited to this. The projection 17 may be formed on the upper surface 15 of the eluent seal member 10, and the projection 18 does not have to be formed on the lower surface 16 of the eluent seal member 10. Alternatively, the projection 18 may be formed on the lower surface 16 of the eluent seal member 10, and the projection 17 does not have to be formed on the upper surface 15 of the eluent seal member 10. Even in these cases, as compared to a case where the projections 17, 18 are not formed, an eluent is prevented from being leaked from the eluent flow path 1.

(b) While the mesh member 14 is provided in the eluent flow path 1 in the above-mentioned embodiment, the embodiment is not limited to this. The mesh member 14 does not have to be provided in the eluent flow path 1. Similarly, while the mesh members 46, 54 are respectively provided in the electrode liquid flow paths 2, 3 in the above-mentioned embodiment, the embodiment is not limited to this. The mesh member 46 does not have to be provided in the electrode liquid flow path 2, and the mesh member 54 does not have to be provided in the electrode liquid flow path 3.

(c) While the through holes 24, 44, 64, 84 for introduction of an eluent into the eluent flow path 1 are respectively formed in the ion exchange membrane 20, the electrode liquid seal member 40, the electrode 60 and the support member 80 in the above-mentioned embodiment, the embodiment is not limited to this. A plurality of through holes for introduction of an eluent into the eluent flow path 1 may be respectively formed in the ion exchange membrane 30, the electrode liquid seal member 50, the electrode 70 and the support member 90.

Similarly, while the through holes 23, 43, 63, 83 for discharge of an eluent from the eluent flow path 1 are respectively formed in the ion exchange membrane 20, the electrode liquid seal member 40, the electrode 60 and the support member 80 in the above-mentioned embodiment, the embodiment is not limited to this. A plurality of through holes for discharge of an eluent from the eluent flow path 1 may be respectively formed in the ion exchange membrane 30, the electrode liquid seal member 50, the electrode 70 and the support member 90.

(d) While an eluent to be discharged from the detector 140 is supplied to the electrode liquid flow paths 2, 3 as an electrode liquid in the above-mentioned embodiment, the embodiment is not limited to this. An eluent that is prepared separately may be supplied to the electrode liquid flow paths 2, 3 as an electrode liquid.

(e) While the one end portion and the other end portion of the ion suppressor 100 are fixed by the two screw members 101, 102 in the above-mentioned embodiment, the embodiment is not limited to this. Portions in the vicinity of the four corners of the ion suppressor 100 may be fixed by four screw members, for example. Further, in a case where the through holes 91, 92 of the support member 90 are screw holes, the nuts 103, 104 do not have to be attached to the screw members 101, 102.

### (7) Inventive Example and Comparative Example

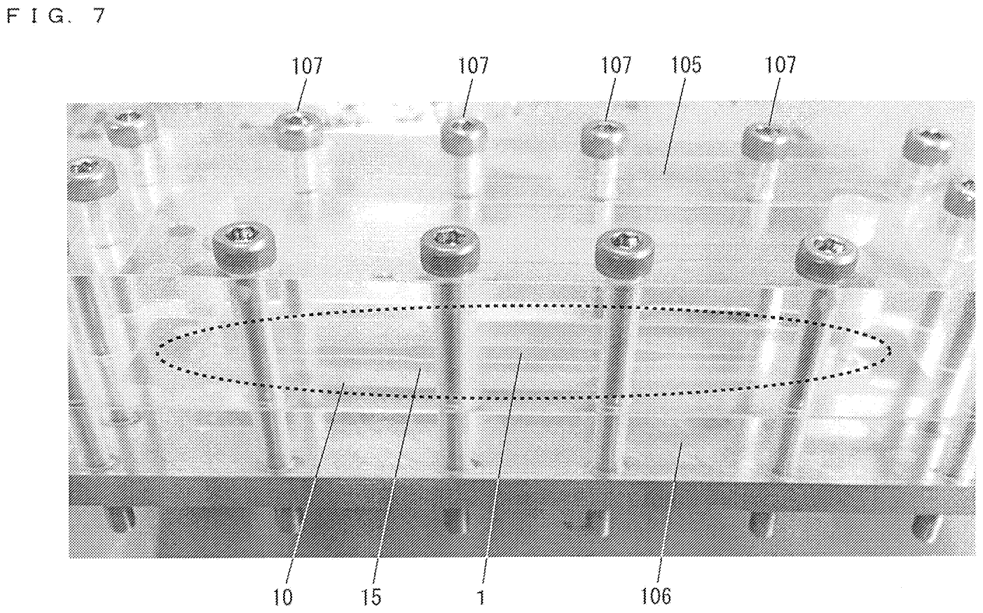

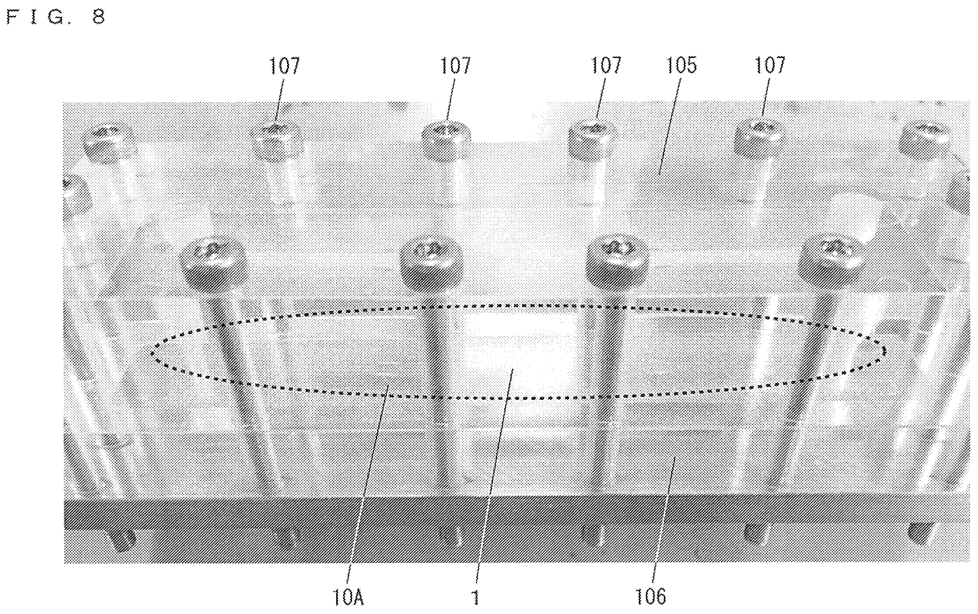

Eluent seal members according to an inventive example and a comparative example were manufactured, and sealability of the eluent seal members was evaluated. FIG. 7 is a picture showing the result of evaluation of an eluent seal member 10 according to the inventive example. FIG. 8 is a picture showing the result of evaluation of an eluent seal member according to the comparative example. The eluent seal member 10 according to the inventive example of FIG. 7 has the similar configuration to that of the eluent seal member 10 of FIG. 3. An eluent seal member 10A according to the comparative example of FIG. 8 has the configuration similar to that of the eluent seal member 10 according to the inventive example except that projections 17, 18 are not formed.

In FIG. 7, the eluent seal member 10 is fixed by a plurality of bolts 107 while being pressed in the up-and-down direction by a pair of transparent acrylic members 105, 106. Similarly, in FIG. 8, the eluent seal member 10A is fixed by the plurality of bolts 107 while being pressed in the up-and-down direction by a pair of transparent acrylic members 105, 106.

As shown in FIG. 7, in the inventive example, the projection 17 is more firmly pressed by the acrylic member 105 than other portions in an upper surface 15 of the eluent seal member 10. Further, the projection 18 (FIG. 4) is pressed more firmly by the acrylic member 106 than other portions in a lower surface 16 of the eluent seal member 10. The firmly pressed portion in the eluent seal member 10 has high sealability and is viewed clearly due to a change in refractive index. Therefore, as indicated by the thick dotted line in FIG. 7, the portion of the eluent seal member 10 surrounded by the firmly pressed portion, that is, the eluent flow path 1 is viewed clearly.

On the other hand, as shown in FIG. 8, in the comparative example, an upper surface 15 of the eluent seal member 10A is pressed by an acrylic member 105 with a uniform pressure. Further, a lower surface 16 of the eluent seal member 10A is pressed by an acrylic member 106 with a uniform pressure. In this case, the portion surrounding the eluent flow path 1 is not sealed with a higher pressure than pressure applied to other portions. Therefore, a change in refractive index of the eluent seal member 10A is uniform. As indicated by the thick dotted line in FIG. 8, the boundary between the eluent flow path 1 and the other portions in the eluent seal member 10A is not clearly viewed. From the result of comparison between FIGS. 7 and 8, it was confirmed that the eluent seal member 10 according to the inventive example has high sealability.

### (8) Correspondences Between Constituent Elements in Claims and Parts in

### PREFERRED EMBODIMENTS

In the above-mentioned embodiment, the electrodes 60, 70 are respectively examples of first and second electrodes, and the electrode liquid seal members 40, 50 are respectively examples of first and second electrode liquid seal members. The ion exchange membranes 20, 30 are respectively examples of first and second ion exchange membranes, the upper surface 15 and the lower surface 16 are respectively examples of first and second surfaces, and the projections 17, 18 are respectively examples of first and second projections.

### (9) Aspects

The inventors of the present invention carried out various experiments and studies repeatedly in order to specify the cause of non-improvement of dialysis efficiency, and obtained the following findings as a result. A sample stream gasket of a suppressor of the Patent Document 1 functions as a seal member that prevents a chromatography effluent flowing through a sample stream screen from leaking to outside. However, the chromatography effluent cannot be confined in the sample stream screen, and part of the chromatography effluent may pass through a position outside of the sample stream screen. In this case, dialysis efficiency is degraded. The inventor of the present invention hit upon the below-mentioned configuration based on the findings.

(Item 1) An ion suppressor according to one aspect that performs ion exchange between an eluent and an electrode liquid from a separation column of an ion chromatograph, may include first and second electrodes, first and second electrode liquid seal members arranged between the first electrode and the second electrode, and respectively have electrode liquid flow paths through which an electrode liquid passes, first and second ion exchange membranes arranged between the first electrode liquid seal member and the second electrode liquid seal member, and an eluent seal member arranged between the first ion exchange membrane and the second ion exchange membrane and has an eluent flow path through which an eluent passes, wherein the eluent seal member may have a first surface that comes into contact with the first ion exchange membrane, and a first projection that surrounds an entire circumference of the eluent flow path to extend along an edge of the eluent flow path and projects toward the first ion exchange membrane may be formed.

In the ion suppressor, the first and second electrode liquid seal members are arranged between the first electrode and the second electrode. The first and second ion exchange membranes are arranged between the first electrode liquid seal member and the second electrode liquid seal member. The eluent seal member is arranged between the first ion exchange membrane and the second ion exchange membrane. Ion exchange is performed between an eluent that passes through the eluent flow path of the eluent seal member from the separation column and an electrode liquid that passes through the electrode liquid flow path of each of the first and second electrode liquid seal members. The first projection that surrounds the entire circumference of the eluent flow path to extend along the edge of the eluent flow path and projects toward the first ion exchange membrane is formed on the first surface of the eluent seal member that comes into contact with the first ion exchange membrane.

In this case, because an eluent is confined in the eluent flow path by the first projection surrounding the entire circumference of the eluent flow path, leakage of the eluent from the eluent flow path is suppressed. Thus, a loss in ion exchange between an eluent and an electrode liquid is reduced. As a result, dialysis efficiency of the ion suppressor can be improved.

(Item 2) The ion suppressor according to item 1, wherein a projection amount of the first projection from the first surface of the eluent seal member may be not less than 3% and not more than 50% of a thickness of the eluent seal member.

In this case, sealability between the eluent seal member and the first ion exchange membrane is more sufficiently improved. Thus, leakage of an eluent from the eluent flow path can be more sufficiently suppressed. As a result, dialysis efficiency of the ion suppressor can be more sufficiently improved.

(Item 3) The ion suppressor according to item 1 or 2, wherein the eluent seal member may be formed of low-density polyethylene.

In this case, the first projection can be sufficiently firmly pressed against the first ion exchange membrane. Thus, leakage of an eluent from the eluent flow path can be more sufficiently suppressed. As a result, dialysis efficiency of the ion suppressor can be more sufficiently improved.

(Item 4) The ion suppressor according to item 1 or 2, wherein the eluent seal member may have a second surface that comes into contact with the second ion exchange membrane, and a second projection that surrounds an entire circumference of the eluent flow path to extend along an edge of the eluent flow path and projects toward the second ion exchange membrane may be formed on the second surface.

In this case, because an eluent is further confined in the eluent flow path by the second projection that surrounds the entire circumference of the eluent flow path, leakage of the eluent from the eluent flow path can be more sufficiently suppressed. Thus, a loss in ion exchange between an eluent and an electrode liquid can be more sufficiently reduced. As a result, dialysis efficiency of the ion suppressor can be more sufficiently improved.

(Item 5) The ion suppressor according to item 4, wherein a projection amount of the second projection from the second surface of the eluent seal member may be not less than 3% and not more than 50% of a thickness of the eluent seal member.

In this case, sealability between the eluent seal member and the second ion exchange membrane is more sufficiently improved. Thus, leakage of an eluent from the eluent flow path can be more sufficiently suppressed. As a result, dialysis efficiency of the ion suppressor can be more sufficiently improved.

1. An ion suppressor that performs ion exchange between an eluent and an electrode liquid from a separation column of an ion chromatograph, comprising:
first and second electrodes;
first and second electrode liquid seal members arranged between the first electrode and the second electrode, and respectively have electrode liquid flow paths through which an electrode liquid passes;
first and second ion exchange membranes arranged between the first electrode liquid seal member and the second electrode liquid seal member; and
an eluent seal member arranged between the first ion exchange membrane and the second ion exchange membrane and has an eluent flow path through which an eluent passes, wherein
the eluent seal member has a first surface that comes into contact with the first ion exchange membrane, and
a first projection that surrounds an entire circumference of the eluent flow path to extend along an edge of the eluent flow path and projects toward the first ion exchange membrane is formed.

2. The ion suppressor according to claim 1, wherein
a projection amount of the first projection from the first surface of the eluent seal member is not less than 3% and not more than 50% of a thickness of the eluent seal member.

3. The ion suppressor according to claim 1, wherein
the eluent seal member and the first projection are formed of low-density polyethylene.

4. The ion suppressor according to claim 1, wherein
the eluent seal member has a second surface that comes into contact with the second ion exchange membrane,
a second projection that surrounds an entire circumference of the eluent flow path to extend along an edge of the eluent flow path and projects toward the second ion exchange membrane is formed on the second surface, and
the second projection is formed of low-density polyethylene.

5. The ion suppressor according to claim 4, wherein
a projection amount of the second projection from the second surface of the eluent seal member is not less than 3% and not more than 50% of a thickness of the eluent seal member.

6. The ion suppressor according to claim 3, wherein
the eluent seal member and the first projection are formed of low-density polyethylene density of which is not less than 0.90 g/cm² and not more than 0.93 g/cm².

7. The ion suppressor according to claim 5, wherein
the eluent seal member and the second projection are formed of low-density polyethylene density of which is not less than 0.90 g/cm² and not more than 0.93 g/cm².
